(19) United States
(12) Patent Application Publication
(10) Pub. No.: US 2009/0324193 A1
(43) Pub. Date: Dec. 31, 2009

(54) BROADCAST RECEIVER AND RECORDING CONTROL METHOD

(75) Inventors: Koichiro Matsuda, Ome-shi (JP); Shinsuke Masuda, Ome-shi (JP); Noriyuki Hazama, Iruma-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/393,916

(22) Filed: Feb. 26, 2009

(30) Foreign Application Priority Data
Jun. 30, 2008 (JP) 2008-171489

(51) Int. Cl. H04N 5/91; H04N 7/173

(52) U.S. Cl. 386/83; 725/131

(57) ABSTRACT

According to one embodiment, a broadcast receiver receives a broadcast signal, and performs predetermined signal processing on the received broadcast signal. The broadcast receiver manages an off-timer function on the basis of an operation input from the user. When the off-timer setting time is set, the broadcast receiver controls to start recording, on a recording medium, a transmitted signal having undergone signal processing.

### CROSS-REFERENCE TO RELATED APPLICATIONS

This application is based upon and claims the benefit of priority from Japanese Patent Application No. 2008-171489, filed Jun. 30, 2008, the entire contents of which are incorporated herein by reference.

### BACKGROUND

1. Field

One embodiment of the invention relates to a broadcast receiver which records content such as television broadcast programs on a recording medium, and a recording control method.

2. Description of the Related Art

These days, television broadcasting has been digitized more and more. For example, in Japan, BS (Broadcasting Satellite) digital broadcasting, 110 CS (Communication Satellite) digital broadcasting, and digital terrestrial broadcasting have started. Along with this, broadcast receivers which receive digital broadcast signals and play back images have become popular recently.

For example, Japanese Patent Application Publication (KOKAI) No. 2005-136576 describes a broadcast receiver which receives digital broadcast signals and plays back images. This broadcast receiver has a function of turning itself off when it has not been operated for a predetermined time.

For example, Japanese Patent Application Publication (KOKAI) No. 2004-236268 describes a broadcast receiver which, when the user sets in advance the time to turn off the broadcast receiver, turns itself off at the set time.

By using a function (off-timer function) of turning off the broadcast receiver upon the lapse of a predetermined time set based on the user operation, this broadcast receiver can prevent wasteful power consumption. For example, when the user falls asleep while watching a program or the like, and cannot turn off the broadcast receiver, the broadcast receiver can turn itself off by the off-timer function.

However, the broadcast receivers described in the Publication No. 2005-136576 and the Publication No. 2004-236268 turn themselves off at the time (off-timer setting time) set by the off-timer function. In such case, the user cannot watch a program played back immediately before power-off. For example, when the user falls asleep while watching a program, he has not watched it to the end.

In this case, the broadcast receiver needs to record a program the user wants in order to provide it to him. However, the above-mentioned conventional broadcast receivers record a program on the basis of recording settings made by the user. To record a program by the broadcast receiver and activate the off-timer function, the user needs to make both the recording setting and off-timer function setting. This complicates the user operation.

When the user wants to watch another program after making both the recording setting and off-timer function setting, he needs to make both of them again. The user may feel the operation is cumbersome.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing an example of the arrangement of a broadcast receiver according to one embodiment of the invention;

FIG. 2 is an exemplary diagram showing the functions of the controller of the broadcast receiver shown in FIG. 1;

FIG. 3A is a flowchart showing off-timer recording executed by the broadcast receiver shown in FIGS. 1 and 2;

FIG. 3B is a flowchart showing off-timer recording executed by the broadcast receiver shown in FIGS. 1 and 2;

FIG. 4 is an exemplary diagram showing a display example of a setup menu window displayed on a video display;

FIG. 5 is an exemplary diagram showing a display example of a window for notifying the user that off-timer recording has started;

FIG. 6 is an exemplary diagram showing a display example of a window for prompting the user to select whether to save data of a program recorded by off-timer recording;

FIG. 7 is an exemplary diagram showing a display example of a window for prompting the user to select whether to record, by off-timer recording, a program to be received next;

FIG. 8 is a flowchart showing playback processing executed by the broadcast receiver shown in FIGS. 1 and 2 for data recorded by off-timer recording;

FIG. 9 is an exemplary diagram showing a display example of a window for prompting the user to select processing of data recorded by off-timer recording; and

FIG. 10 is an exemplary diagram showing the arrangement of a broadcast receiver according to another embodiment

### DETAILED DESCRIPTION

Various embodiments according to the invention will be described hereinafter with reference to the accompanying drawings. In general, according to one embodiment of the invention, a broadcast receiver comprises a receiving module which receives a broadcast signal, a signal processing module which performs predetermined signal processing on the broadcast signal received by the receiving module, a recording module which records, on a recording medium, a signal transmitted from the signal processing module, an operation input module which converts an operation input into an operation signal, an off-timer management module which manages an off-timer function on the basis of the operation signal from the operation input module, and an off-timer recording control module which, when the off-timer management module sets the off-timer setting time, controls to start recording by the recording module.

Embodiments of this invention will be described in detail with reference to the drawings.

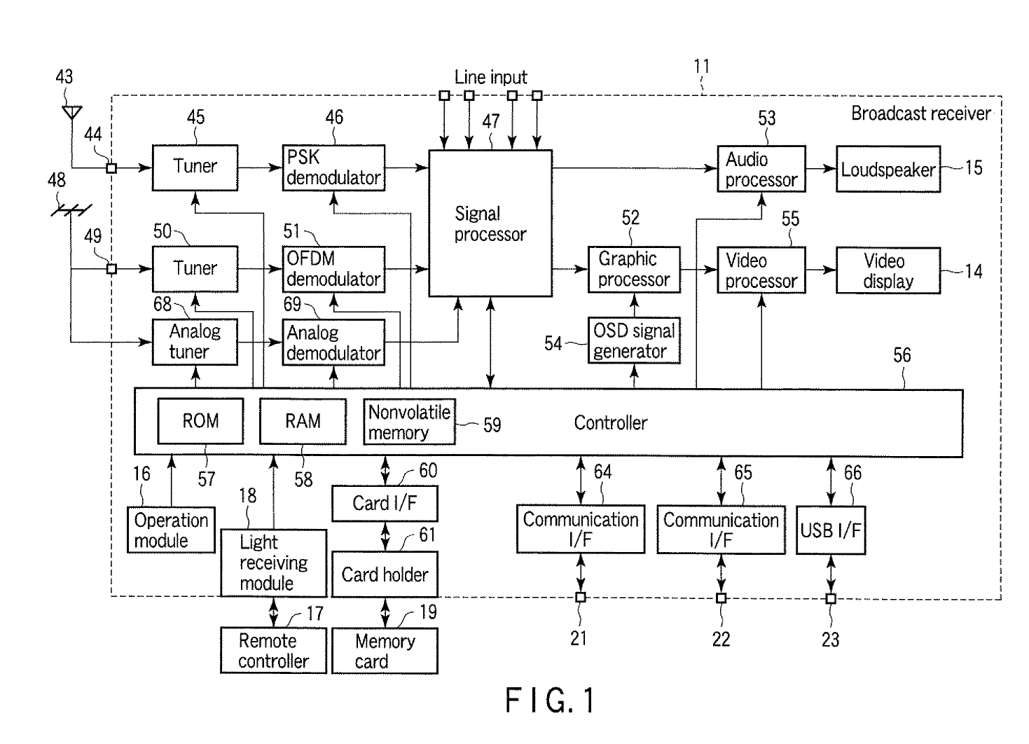

FIG. 1 is an exemplary diagram showing an example of the arrangement of a broadcast receiver 11 according to one embodiment of the invention.

The broadcast receiver 11 comprises an antenna 43, input terminal 44, tuner 45, PSK (Phase Shift Keying) demodulator 46, signal processor 47, antenna 48, input terminal 49, tuner 50, OFDM (Orthogonal Frequency Division Multiplexing) demodulator 51, analog tuner 68, and analog demodulator 69. The antenna 43, input terminal 44, tuner 45, PSK demodulator 46, signal processor 47, antenna 48, input terminal 49, tuner 50, OFDM demodulator 51, analog tuner 68, and analog demodulator 69 function as a receiving module. The receiving module is comprised of an antenna, tuner, and demodulator set.

The antenna 43 is used to receive BS and CS digital broadcasts. The antenna 43 receives a satellite digital television broadcast signal. The input terminal 44 supplies a digital broadcast signal received by the antenna 43 to the tuner 45.

The tuner 45 is used for satellite digital broadcasts. The tuner 45 tunes a received digital broadcast signal. The tuner 45 transmits the tuned digital broadcast signal to the PSK demodulator 46.

The PSK demodulator 46 demodulates a digital broadcast signal. The PSK demodulator 46 transmits the demodulated digital broadcast signal to the signal processor 47.

The antenna 48 is used to receive a digital terrestrial broadcast. The antenna 48 receives a digital terrestrial television broadcast signal. The input terminal 49 supplies the digital broadcast signal received by the antenna 48 to the tuner 50.

The tuner 50 is used for digital terrestrial broadcasts. The tuner 50 tunes a received digital broadcast signal. The tuner 50 transmits the tuned digital broadcast signal to the OFDM demodulator 51.

The OFDM demodulator 51 demodulates a digital broadcast signal. The OFDM demodulator 51 transmits the demodulated digital broadcast signal to the signal processor 47.

The antenna 48 can also receive terrestrial analog broadcast signals. A terrestrial analog broadcast signal received by the antenna 48 is distributed by a distributor (not shown), and supplied to the analog tuner 68.

The analog tuner 68 tunes a received analog broadcast signal. The analog tuner 68 transmits the tuned analog broadcast signal to the analog demodulator 69.

The analog demodulator 69 demodulates an analog broadcast signal. The analog demodulator 69 transmits the demodulated analog broadcast signal to the signal processor 47.

The signal processor 47 functions as a signal processing module. The signal processor 47 performs digital signal processing on digital broadcast signals received from the PSK demodulator 46 and OFDM demodulator 51. More specifically, the signal processor 47 divides a digital broadcast signal into a data signal, video signal, and audio signal. The signal processor 47 supplies the data signal to an OSD (On Screen Display) signal generator 54. The signal processor 47 transmits the video signal to a graphic processor 52. The signal processor 47 transmits an audio signal to an audio processor 53.

The signal processor 47 converts a broadcast signal received from the analog demodulator 69 into a digital video signal and audio signal of a predetermined format. The signal processor 47 transmits the converted digital video signal to the graphic processor 52. The signal processor 47 transmits the converted digital audio signal to the audio processor 53.

The signal processor 47 converts an input signal from a line input terminal into a digital signal.

The broadcast receiver 11 also comprises the graphic processor 52, the audio processor 53, the OSD signal generator 54, a video processor 55, a video display 14, and a loudspeaker 15.

The OSD signal generator 54 generates an OSD signal for displaying a UI (User Interface) window and the like under the control of a controller 56.

The OSD signal generator 54 converts a data signal received from the signal processor 47 into an OS signal of a format suited to the broadcast receiver 11. The OSD signal generator 54 transmits the OSD signal to the graphic processor 52.

The graphic processor 52 decodes a digital video signal received from the signal processor 47. The graphic processor 52 superposes and synthesizes the decoded video signal and an OSD signal received from the OSD signal generator 54. The graphic processor 52 transmits the synthesized signal to the video processor 55.

The graphic processor 52 can also selectively transmit either a decoded video signal or OSD signal to the video processor 55. The graphic processor 52 can also transmit a combination of a video signal and OSD signal so that each of them forms half the frame.

The video processor 55 converts a signal input from the graphic processor 52 into an analog video signal of a format that can be displayed on the video display 14. The video processor 55 transmits the converted analog video signal to the video display 14. The video display 14 displays the received video signal.

The audio processor 53 converts an audio signal received from the signal processor 47 into an analog audio signal of a format that can be played back from the loudspeaker 15. The audio processor 53 transmits the converted analog audio signal to the loudspeaker 15. The loudspeaker 15 plays back the received audio signal.

The broadcast receiver 11 further comprises an operation module 16 and light receiving module 18. Each of the operation module 16 and light receiving module 18 functions as an operation input module. The operation module 16 generates an operation signal in accordance with an operation input from the user. The operation module 16 supplies the generated operation signal to the controller 56.

The light receiving module 18 receives an operation signal from a remote controller 17. The light receiving module 18 supplies the operation signal received from the remote controller 17 to the controller 56.

The remote controller 17 comprises a power key, an input switching key, a direct channel selection key for satellite digital broadcast channels, a direct channel selection key for terrestrial broadcast channels, a quick key, a cursor key, an OK key, a program guide key, a page switching key, a channel up/down key, a volume control key, an off-timer key, and the like. The remote controller 17 generates an operation signal on the basis of an operation input from the user, and supplies it to the light receiving module 18.

The broadcast receiver 11 further comprises the controller 56, a ROM 57, a RAM 58, and a nonvolatile memory 59. The controller 56 controls the operation of each module of the broadcast receiver. The controller 56 comprises a CPU and the like. The controller 56 performs various processes on the basis of an operation signal supplied from the operation module 16 or light receiving module 18.

The ROM 57 stores the system control program of the broadcast receiver 11, various processing programs, and the like. The RAM 58 functions as the work memory of the CPU. The nonvolatile memory 59 stores various kinds of information such as setting information and control information necessary to control the operation of the broadcast receiver 11.

The controller 56 activates a program stored in the ROM 57 on the basis of an operation signal supplied from the operation module 16 or light receiving module 18. The controller 56 executes processing to control the operation of each module of the broadcast receiver on the basis of control information and setting information stored in the nonvolatile memory 59.

The broadcast receiver 11 also comprises a LAN terminal 21, LAN terminal 22, USB (Universal Serial Bus) terminal 23, card I/F (interface) 60, card holder 61, communication I/F 64, communication I/F 65, and USB I/F 66.

The card holder 61 is connected to the controller 56 via the card I/F 60. The card holder 61 allows to mount a memory card 19. The memory card 19 is a portable storage medium.

The card I/F 60 reads the memory contents of the memory card 19 mounted in the card holder 61. The card I/F 60 supplies the read data to the controller 56.

The card I/F 60 can write a variety of data such as images, music, and broadcast programs in the memory card 19 under the control of the controller 56.

The controller 56 can cause the video display 14 or loudspeaker 15 to display or play back data such as images, music, or broadcast programs obtained by reading the memory card 19 by the card I/F 60.

The LAN terminals 21 and 22 allow to mount a LAN cable. The communication I/Fs 64 and 65 can transmit and receive data via LAN cables connected to the LAN terminals 21 and 22. More specifically, the communication I/Fs 64 and 65 can transmit and receive data to and from an external device (e.g., an HDD) connected via the LAN cables.

Examples of the connected external device are a LAN HDD using Ethernet®, a NAS (Network Attached Storage) HDD, a PC (Personal Computer), and a readable/writable optical disk drive. The controller 56 can transport information to the external device via the communication I/Fs 64 and 65.

In this case, the controller 56 functions as a DHCP (Dynamic Host Configuration Protocol) server. More specifically, the controller 56 assigns an IP (Internet Protocol) address to the HDD connected to the LAN terminal 21 or 22 to control the HDD.

Hence, the controller 56 can store data such as images, music, and broadcast programs in the HDD. Also, the controller 56 can read out data such as images, music, and broadcast programs stored In the HDD, and transmit them to the video display 14 and loudspeaker 15.

The controller 56 can record information on the HDD connected to the LAN terminal 21 or 22.

When the controller 56 is connected to a broadband router via the LAN terminal 21 or 22, it can connect to a network via the broadband router.

The USB terminal 23 is connected to the controller 56 via the USB I/F 66. The USB terminal 23 is a general USB port. The controller 56 can communicate data with a cell phone, digital camera, HDD, and the like connected to the USB terminal 23.

In the above description of the embodiment, the HDD is externally connected, but is not limited to this. For example, the HDD may also be incorporated by connecting it to the controller 56 via an internal bus or the like in the broadcast receiver. The controller 56 can record data such as broadcast programs on a storage medium which can communicate with the controller 56. More specifically, the controller 56 functions as a recording module which records a signal transmitted from the signal processor on a recoding medium.

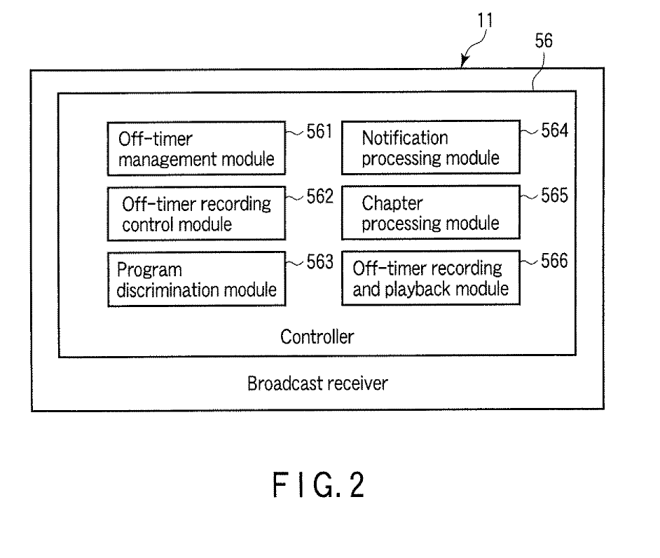

FIG. 2 is an exemplary diagram showing the functions of the controller 56 of the broadcast receiver 11 shown in FIG. 1.

The controller 56 comprises an off-timer management module 561, off-timer recording control module 562, program discrimination module 563, notification processing module 564, chapter processing module 565, and off-timer recording and playback module 566.

The off-timer management module 561 controls the above-described off-timer function. More specifically, the off-timer management module 561 sets the off-timer setting time on the basis of an operation signal input to the controller 56. The off-timer setting time is information for designating the time to execute the off-timer function. The off-timer management module 561 sets the off-timer setting time to execute the off-timer unction after a predetermined time such as 30 min, 60 min, or 90 min on the basis of the user operation.

The off-timer management module 561 has a timepiece function. The off-timer management module 561 continually determines whether the off-timer setting time has come. If the off-timer management module 561 determines that the off-timer setting time has come, it controls to turn off the broadcast receiver 11 or change It to the standby state.

The off-timer recording control module 562 controls an off-timer recording function. When the off-timer management module 561 sets the off-timer setting time, the off-timer recording control module 562 starts recording the program of a selected channel. More specifically, when the off-timer setting time is set, the off-timer recording control module 562 starts off-timer recording.

At the start of recording a program, the off-timer recording control module 562 checks the available space of a storage medium (e.g., an HDD) which saves a recorded program. From the capacity of the program of a channel selected upon setting the off-timer function and the user setting (e.g., the setting of the image quality in save), the off-timer recording control module 562 checks the capacity necessary to record a certain program.

The off-timer recording control module 562 compares the space area of the storage medium with the capacity necessary to record a program, and determines whether the program can be recorded to the end. The size of a program can be checked by various methods. For example, the off-timer recording control module 562 checks the size of a program on the basis of program specifying information included in a stream of digital broadcast signals received by the broadcast receiver 11.

When an operation signal for selecting another channel is received during execution of off-timer recording, the off-timer recording control module 562 discards data of a program recorded by off-timer recording. Then, the off-timer recording control module 562 determines the space necessary for recording from the size of the program of the selected channel. The off-timer recording control module 562 determines whether recording is possible, and if possible, starts off-timer recording of the program of the selected channel.

When an operation signal for changing the broadcast receiver to the standby state is received during execution of off-timer recording, the off-timer recording control module 562 discards data of a program recorded by off-timer recording upon receiving the operation signal.

When the off-timer recording control module 562 executes off-timer recording at the off-timer setting time, the off-timer management module 561 controls the power supply of the broadcast receiver 11 to the standby state. The off-timer management module 561 controls to turn off the broadcast receiver 11 at the end of off-timer recording by the off-timer recording control module 562. More specifically, when the off-timer recording control module 562 determines that a program recorded by off-timer recording has ended, the off-timer management module 561 controls to turn off the broadcast receiver 11.

The program discrimination module 563 discriminates the broadcast time on the basis of program specifying information included in a stream of digital broadcast signals received by the broadcast receiver 11. More specifically, the program discrimination module 563 discriminates the start and end times of a program on the basis of the program specifying information.

The program discrimination module 563 monitors the end time of a program which is being recorded during execution of off-timer recording. When the end time of the program is approaching, the program discrimination module 563 notifies the off-timer recording control module 562 and notification processing module 564 of a message to this effect.

When notified that the end time of the program is approaching, the notification processing module 564 creates display data for prompting the user to select whether to save data of the program recorded by off-timer recording. The notification processing module 564 transmits the created display data to the display device to display it.

The off-timer recording control module 562 discriminates an operation signal from the user at this time, and determines whether to save data of a program recorded by off-timer recording.

When the off-timer recording control module 562 saves or discards data of a program recorded by off-timer recording, the notification processing module 564 creates display data for prompting the user to select whether to record, by off-timer recording, a program to be received next.

When the off-timer recording control module 562 discriminates an operation signal from the user at this time, and determines that the operation signal represents execution of off-timer recording, it determines the space necessary for recording from the size of the next program. After determining whether recording is possible, the off-timer recording control module 562 starts off-timer recording of the program of a selected channel.

When the broadcast receiver 11 is activated, the notification processing module 564 notifies the user that there is data recorded by off-timer recording among recorded data. The notification processing module 564 issues this notification when it has not notified yet to the user that there is data recorded by off-timer recording. In this case, the notification processing module 564 stores a log of notifications in the nonvolatile memory 59 or the like.

The notification processing module 564 creates display data for prompting the user to select a process for data of a program recorded by off-timer recording. The notification processing module 564 transmits the created display data to the display device to display it.

Upon receiving an operation signal other than the above-mentioned ones, i.e., the channel selection signal and standby signal during execution of off-timer recording, the chapter processing module 565 adds a chapter to a recording position corresponding to the time when the operation signal was received. When a chapter has already been added, the chapter position may also be updated. A program can be played back from a position closest to a portion considered to be missed by the user.

The off-timer recording and playback module 566 plays back data recorded by off-timer recording, and manages data. More specifically, the off-timer recording and playback module 566 plays back recorded data and manages data on the basis of an operation signal from the user in response to a display presented by the notification processing module 564 to prompt him to select processing of data of a program recorded by off-timer recording.

It is determined whether the chapter processing module 565 has added a chapter to the recorded data. if a chapter has been added, the off-timer recording and playback module 566 starts playback from the chapter-added position.

When discard of recorded data is designated by an operation signal from the user, the off-timer recording and playback module 566 controls to delete the data recorded by off-timer recording from the storage medium.

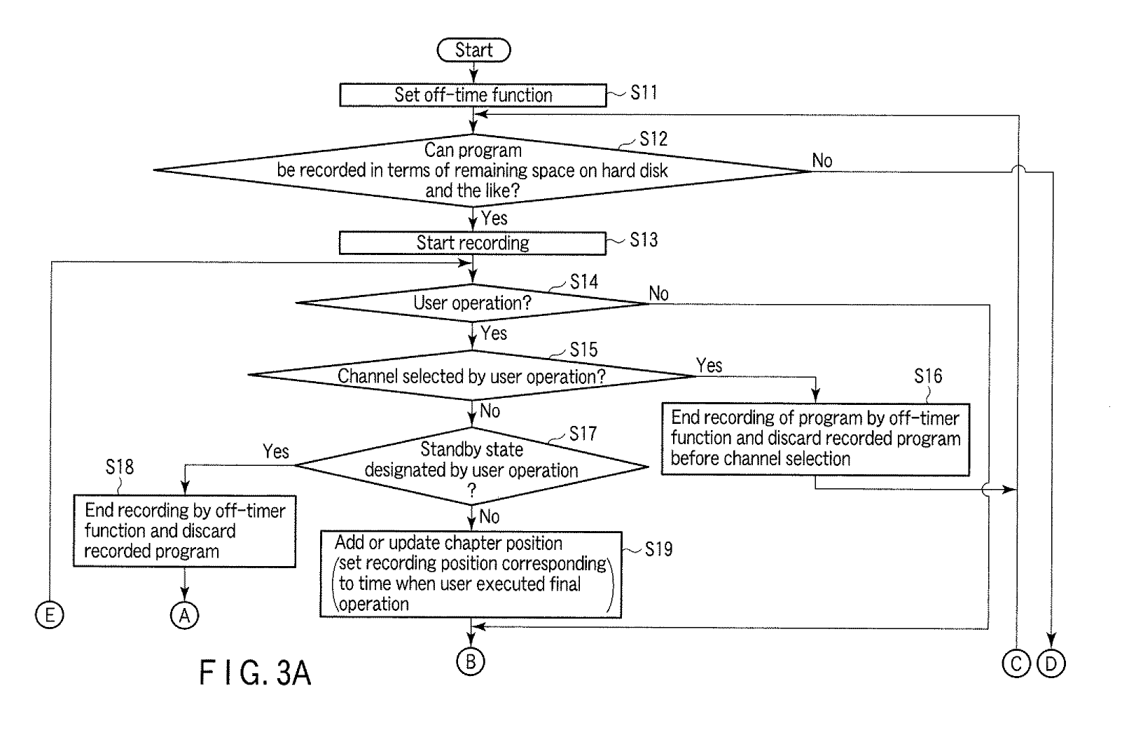

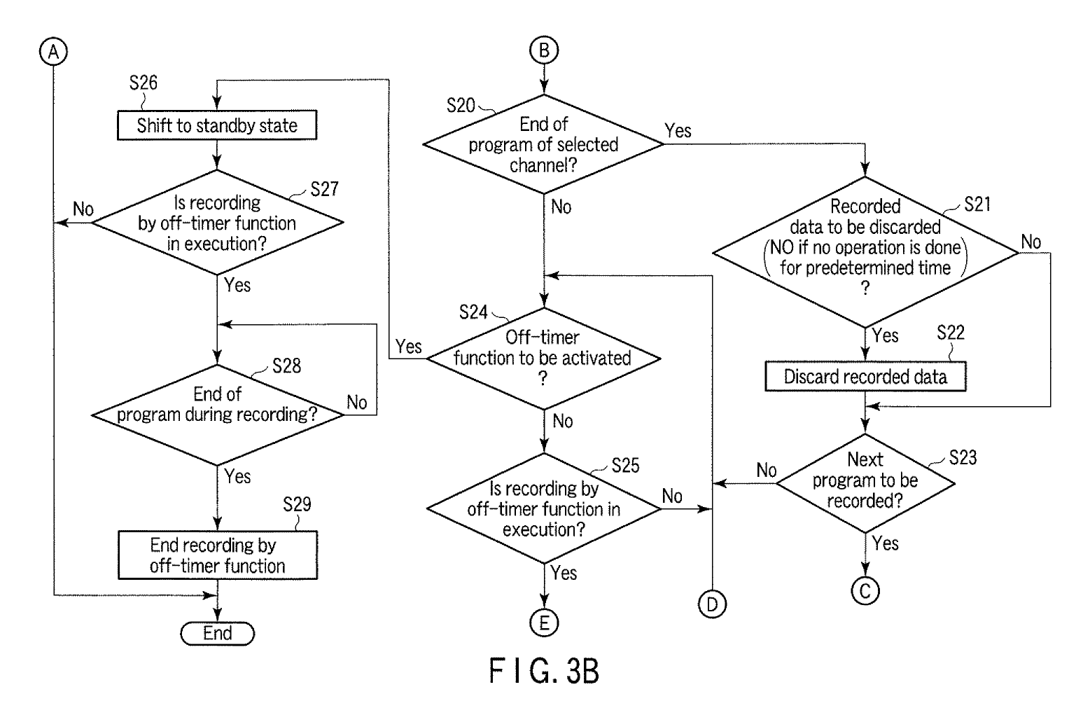

FIGS. 3A and 3B are flowcharts showing off-timer recording executed by the broadcast receiver 11 shown in FIGS. 1 and 2.

Assume that the broadcast receiver 11 is receiving digital broadcast signals. If the broadcast receiver 11 receives an off-timer function setting operation signal In accordance with the user operation, the off-timer management module 561 sets the off-timer setting time on the basis of the input operation signal (step S11). For example, when the user operates the off-timer key of the remote controller 17, the remote controller 17 transmits an off-timer function setting operation signal to the light receiving module 18.

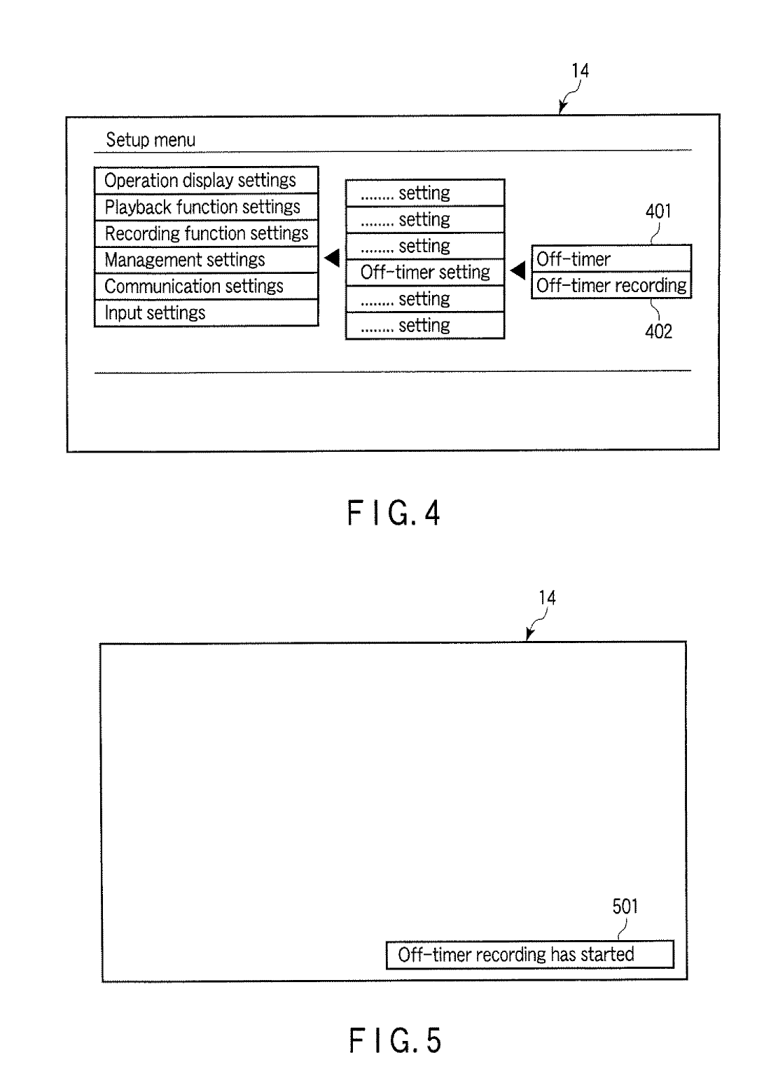

The user can set, in a setup menu as shown in FIG. 4, which of the off-timer function and off-timer recording is executed with the off-timer key. FIG. 4 shows a display example of a setup menu window displayed on the video display 14.

Based on this user operation, the controller 56 sets the off-timer function or off-timer recording which is executed upon pressing the off-timer key. More specifically, when the user selects an “off-timer” 401 in the setup menu window, the controller 56 sets to execute the off-timer function upon pressing the off-timer key. When the user selects an “off-timer recording” 402 in the setup menu window, the controller 56 sets to execute off-timer recording upon pressing the off-timer key.

It is also possible to prompt the user to select which of the off-timer function or off-timer recording is executed when an off-timer key operation signal is input.

After the off-timer management module 561 sets the off-timer setting time, the off-timer recording control module 562 determines whether the program of a selected channel can be recorded (step S12). More specifically, the off-timer recording control module 562 compares the available space of the storage medium with that necessary to record the program, and determines whether the program can be recorded to the end.

If the off-timer recording control module 562 determines that the program can be recorded (YES in step S12), it starts off-timer recording (step S13). In this case, the controller 56 displays a window as shown in FIG. 5 on the video display 14. FIG. 5 shows a display example of a window for notifying the user that off-timer recording has started. This window comprises a character string “off-timer recording has started” 501.

If the off-timer recording control module 562 determines that no program can be recorded (NO in step S12), it sets only the off-timer function without performing off-timer recording.

During execution of off-timer recording, the controller 56 always determines whether an operation signal has been received (step S14). If the controller 56 determines that an operation signal has been received (YES in step S14), it determines whether the received operation signal is a channel selection instruction, standby instruction, or other instruction (steps S15 and S17).

If the controller 56 determines that the received operation signal is a channel selection instruction (YES in step S15), the off-timer recording control module 562 discards data of the program which is being recorded by off-timer recording (step S16). The off-timer recording control module 562 shifts to step S12 to determine the space necessary for recording from the size of the program of a selected channel. Further, the off-timer recording control module 562 determines whether recording is possible, and starts off-timer recording of the program of the selected channel.

if the controller 56 determines that the received operation signal is a standby instruction (YES in step S17), the off-timer recording control module 562 discards data of the program which is being recorded by off-timer recording (step S18). Then, the process ends.

If the controller 56 determines that the received operation signal is another instruction (NO in step S17), the chapter processing module 565 adds a chapter to a recoding position corresponding to the time when the operation signal was received (step S19).

The program discrimination module 563 continuously determines whether the program has ended (step S20). If the program discrimination module 563 determines that the program has ended (YES in step S20), the notification processing module 564 displays a window on the video display 14 to prompt the user to select whether to save the data of the program recorded by off-timer recording.

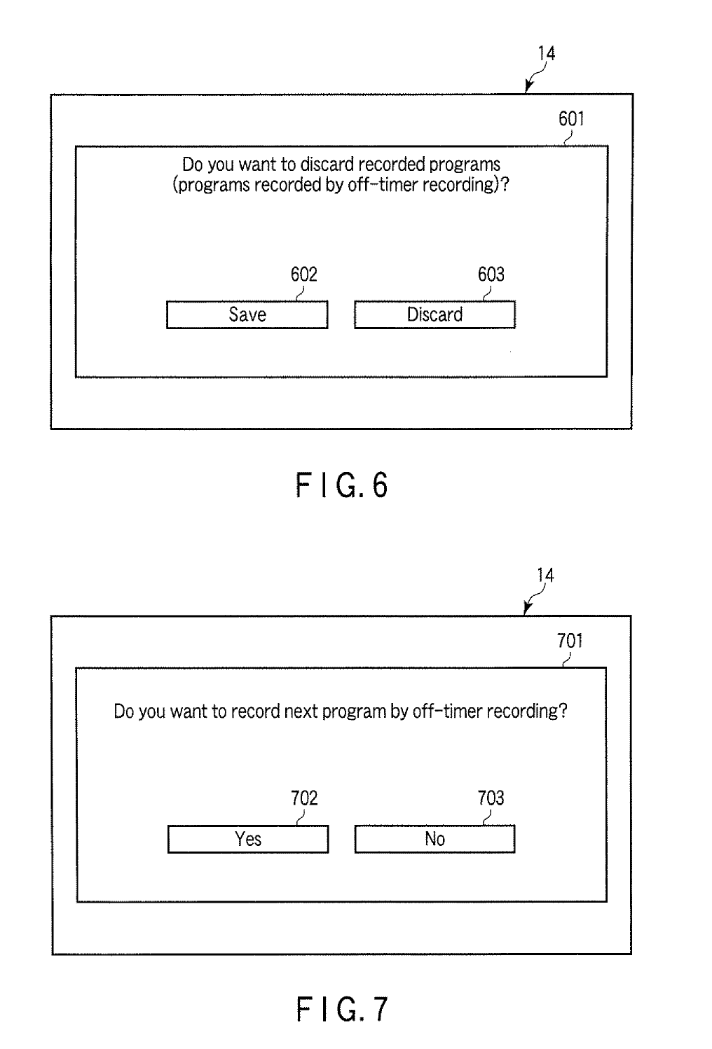

FIG. 6 shows a display example of a window for prompting the user to select whether to save data of a program recorded by off-timer recording. The window shown in FIG. 6 presents a character string 601 which prompts the user to make a selection, a “save” button 602, and a “discard” button 603.

The off-timer recording control module 562 discriminates an operation signal from the user via the window, and determines whether to save data of the program recorded by off-timer recording (step S21). The notification processing module 564 and operation input module configure a selection module which prompts the user to select whether to delete, from the recording medium, data of a program recorded by off-timer recording.

If the user presses the button 602 and an operation signal which designates save of data of a program recorded by off-timer recording is received, or if no operation is received from the user for a predetermined time, the off-timer recording control module 562 saves data of the program recorded by off-timer recording in the storage medium.

If the user presses the button 603 and an operation signal which designates discard of data of a program recorded by off-timer recording is received, the off-timer recording control module 562 discards data of the program recorded by off-timer recording (step S22).

After the off-timer recording control module 562 saves or discards data of the program recorded by off-timer recording, the notification processing module 564 displays a window on the video display 14 to prompt the user to select whether to record, by off-timer recording, a program to be received next.

FIG. 7 shows a display example of a window for prompting the user to select whether to record, by off-timer recording, a program to be received next. The display shown in FIG. 7 presents a character string 701 which prompts the user to make a selection, a “Yes” button 702, and a “No” button 703.

The off-timer recording control module 562 discriminates an operation signal from the user via the window, and determines whether to record, by off-timer recording, a program to be received next (step S23). The notification processing module 564 and operation input module configure a selection module which prompts the user to select whether to record a program to be received next.

If it is determined that the user has pressed the button 702 to record, by off-timer recording, a program to be received next (YES in step S23), the off-timer recording control module 562 shifts to step S12 to determine the space necessary for recording from the size of the program of a selected channel. Further, the off-timer recording control module 562 determines whether recording is possible, and if possible, starts off-timer recording of the program of the selected channel.

If it is determined that the user has pressed the button 703 not to record, by off-timer recording, a program to be received next, or if no operation is input from the user for a predetermined time (NO in step S23), the off-timer recording control module 562 ends off-timer recording, and executes only the normal off-timer function.

The off-timer management module 561 continuously determines whether the off-timer setting time has come (step S24). If the controller 56 determines that no off-timer setting time has come (NO in step S24), and off-timer recording is in execution (YES in step S25), the controller 56 shifts to step S14 to determine whether an operation signal has been received.

If the controller 56 determines in step S24 that the off-timer setting time has come, the off-timer management module 561 controls the power supply of the broadcast receiver 11 to the standby state (step S26).

The off-timer management module 561 determines whether off-timer recording is in execution (step S27). If the off-timer management module 561 determines that no off-timer recording is in execution (NO in step S27), it turns off the broadcast receiver 11, and the process ends.

If the off-timer management module 561 determines that off-timer recording is in execution (YES in step S27), the off-timer recording control module 562 waits for the end of the program (step S28). More specifically, the off-timer recording control module 562 waits for information which is notified from the program discrimination module 563 and represents the end of the program.

If it is determined that the program has ended (YES in step S28), the off-timer recording control module 562 ends off-timer recording (step S29). The off-timer management module 561 turns off the broadcast receiver 11, and the process ends.

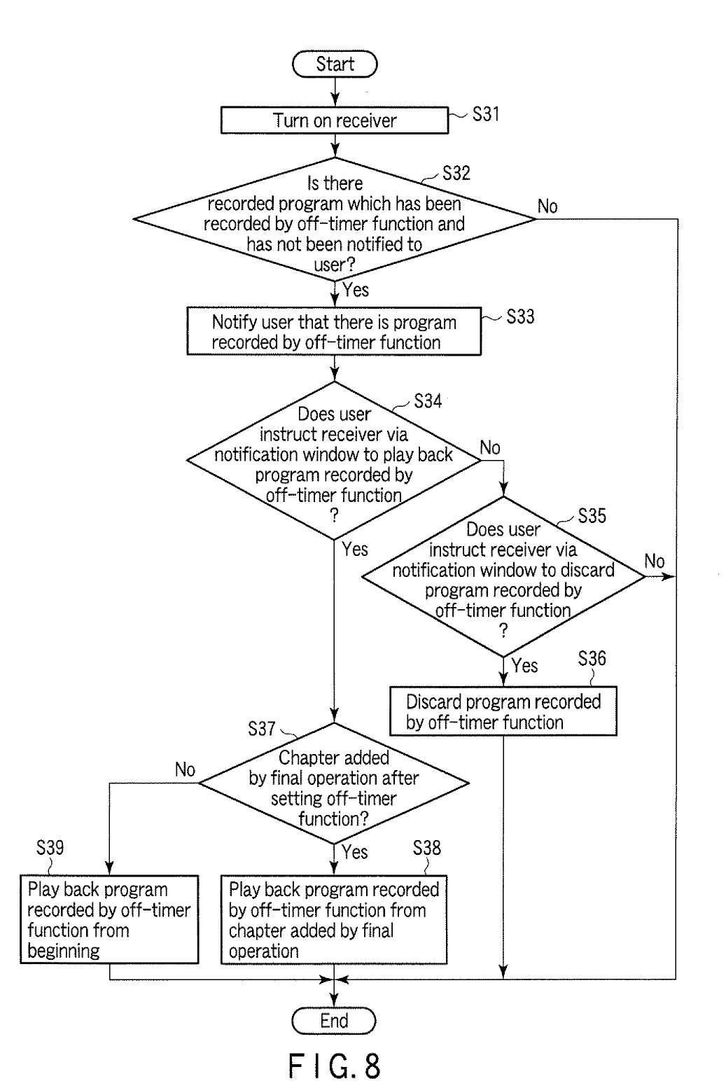

FIG. 8 is a flowchart showing playback processing executed by the broadcast receiver 11 shown in FIGS. 1 and 2 for data recorded by off-timer recording.

When the broadcast receiver 11 is activated (step S31), the notification processing module 564 refers to the memory contents of the storage medium to determine whether there is a program which has been recorded by off-timer recording and has not been notified by the notification processing module 564 (step S32). More specifically, the controller 56 compares programs recorded by off-timer recording among programs stored in the storage medium with the notification log of the notification processing module 564.

If the notification processing module 564 determines that it has notified all programs recorded by off-timer recording (NO in step S32), the controller 56 ends the process.

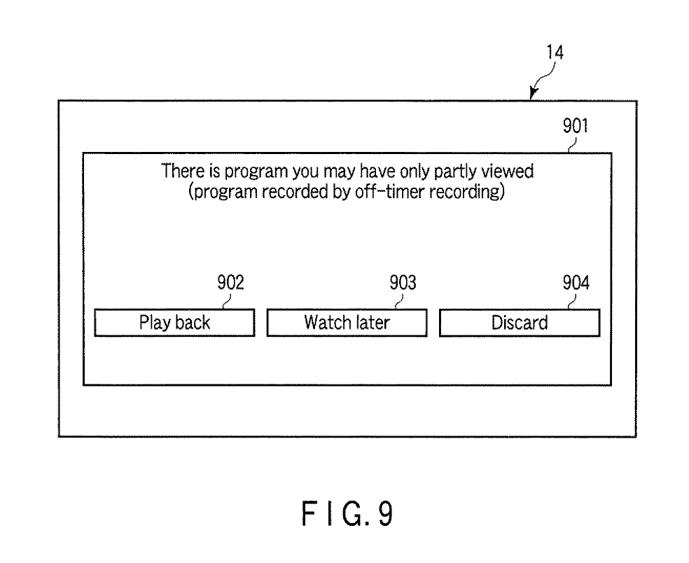

If the notification processing module 564 determines that there is a program which has not been notified by the notification processing module 564 (YES in step S32), it notifies the user that there is data recorded by off-timer recording (step S33). In this case, the notification processing module 564 creates display data of a window as shown in FIG. 9, and displays it on the video display 14.

FIG. 9 shows a display example of a window for prompting the user to select processing of data recorded by off-timer recording.

The window shown in FIG. 9 presents a character string 901 which prompts the user to make a selection, a “play back” button 902, a “watch later” button 903, and a “discard” button 904.

The off-timer recording and playback module 566 discriminates an operation signal from the user, and determines processing of data recorded by off-timer recording (steps S34 and S35).

If the off-timer recording and playback module 566 determines that the user has pressed the button 903 to suspend processing of data recorded by off-timer recording (NO in step S35), it ends the process.

if the off-timer recording and playback module 566 determines that the user has pressed the button 904 to discard data recorded by off-timer recording (YES in step S35), it controls to delete the data recorded by off-timer recording from the storage medium (step S36).

If the off-timer recording and playback module 566 determines that the user has pressed the button 902 to play back data recorded by off-timer recording (YES in step S34), it determines whether the chapter processing module 565 has added a chapter to data recorded by off-timer recording (step S37).

If the chapter has been added (YES in step S37), the off-timer recording and playback module 566 plays back the data recorded by off-timer recording from the chapter-added position (step S38).

If no chapter has been added (NO in step S37), the off-timer recording and playback module 566 plays back the data recorded by off-timer recording from the beginning (step S39).

According to the above-described embodiment, when it is determined that there is a program not notified by the notification processing module 564, the user is notified that there is data recorded by off-timer recording. However, the invention is not limited to this. For example, the notification processing module 564 may also notify the user of data which has not been played back yet among data recorded by off-timer recording.

The broadcast receiver 11 according to the above-described embodiment comprises the video display 14 and loudspeaker 15, but the invention is not limited to this. The invention is also applicable to an arrangement in which the video display 14 and Loudspeaker 15 are externally connected.

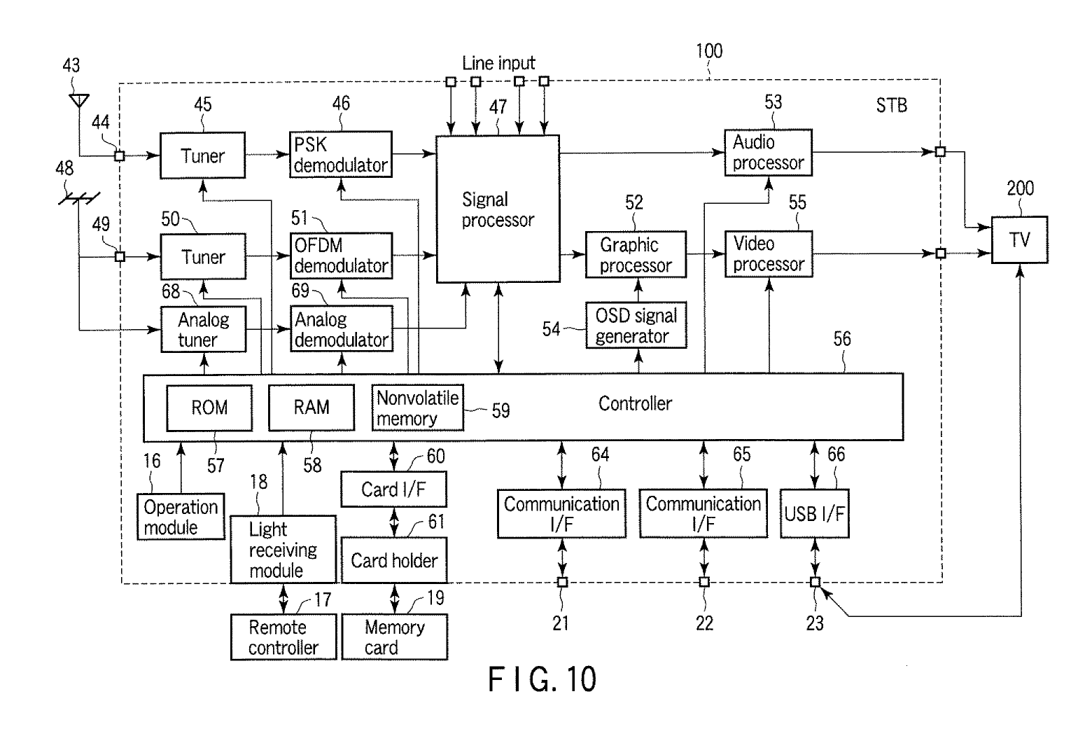

FIG. 10 is an exemplary diagram showing the arrangement of a broadcast receiver (STB: Set Top Box) 100 according to another embodiment. The same reference numerals as those of the arrangement shown in FIG. 1 denote the same parts, and a detailed description thereof will not be repeated.

The STB 100 is configured by excluding the video display 14 and loudspeaker 15 from the broadcast receiver 11 shown in FIG. 1. An audio processor 53 and video processor 55 of the STB 100 transmit signals outside the STB 100 via output terminals. A television (TV) 200 is connected to the output terminals. The video processor 55 transmits a converted analog video signal to the TV 200. The audio processor 53 transmits a converted analog audio signal to the TV 200.

The TV 200 comprises a loudspeaker, display, power controller, and communication interface. The TV 200 displays an image on the display on the basis of a received video signal. The TV 200 plays back speech from the loudspeaker on the basis of a received audio signal.

The STB 100 and TV 200 are connected to each other via a USB cable, LAN cable, or the like so that they can communicate data.

For example, when the STB 100 and TV 200 are connected via a USB cable, the STB 100 can transmit, to the TV 200 via the USB cable, a signal (power control signal) for controlling the power supply of the TV 200.

Upon receiving the power control signal via the communication interface, the power controller of the TV 200 switches the power supply of the TV 200 between the ON and OFF states on the basis of the power control signal.

More specifically, when an off-timer management module 561 of the STS 100 determines that the off-timer setting time has come, it transmits a power control signal to the TV 200 to instruct it to turn itself off. Upon receiving the power control signal which instructs the TV 200 to turn itself off, the power controller of the TV 200 turns off the TV 200.

As described above, when the off-timer function is set, the broadcast receiver according to the embodiment of the invention automatically starts recording the program of a channel selected at this time. When the off-timer setting time has come during recording, the broadcast receiver executes recording up to the end of the current program, and then is turned off. When an operation to select a channel is done during recording, the broadcast receiver discards recorded data, and automatically starts recording the program of the selected channel. Upon activation, the broadcast receiver checks whether there is a program recorded by off-timer recording. If there is a program recorded by off-timer recording, the broadcast receiver notifies the user of a message to this effect.

By merely setting the off-timer, the user can cause the broadcast receiver to record a program he is watching. Even when the user selects a channel, the broadcast receiver is made to automatically record the program of the selected channel, therefore the user can record a program in the broadcast receiver without any consciousness of it. When the user selects a channel, the broadcast receiver discards recorded data. Hence, the broadcast receiver can provide a program the user wants, without leaving unnecessary data in the storage medium. The invention can, therefore, provide a broadcast receiver and recording control method capable of further improving user friendliness.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A broadcast receiver comprising:
a receiving module configured to receive a broadcast signal;
a signal processing module configured to perform predetermined signal processing on the broadcast signal received by the receiving module;
a recording module configured to record, on a recording medium, a signal output from the signal processing module;
an operation input module configured to convert an operation input into an operation signal;
an off-timer management module configured to manage an off-timer function on the basis of the operation signal from the operation input module;
an off-timer recording control module configured to perform control such that:
when the off-timer management module sets an off-timer setting time, the recording module the recording module starts recording;
when the operation input module is operated during recording to select a channel, the recording of a broadcast signal from the channel selected by the channel selection operation is started; and
when the operation input module is operated during recording to select a channel or switch the broadcast receiver into a standby state, data recorded by off-timer recording on the recording medium when the operation is performed is deleted; and
a program discrimination module configured to discriminate a program end time on the basis of an output signal output from the signal processing module,
wherein the off-timer recording control module ends recording when the program discrimination module discriminates an end of a program recorded when the off-timer management module determines that the off-timer setting time has come.

2-4. (canceled)

5. The receiver according to claim 1, further comprising a selection module configured to, when the program discrimination module discriminates an end of a program, prompt a user to select whether to delete, from the recording medium, data of the program, recording of which has ended, and
in which when the user selects, from the selection module, to delete, from the recording medium, data of the program, recording of which has ended, the off-timer recording control module controls to delete, from the recording medium, the data of the program, recording of which has ended.

6. The receiver according to claim 1, further comprising a selection module configured to, when the program discrimination module discriminates an end of a program, prompt a user to select whether to record a program to be received next, and
in which when the user selects, from the selection module, to record a program to be received next, the off-timer recording control module controls to record the program to be received next.

7. The receiver according to claim 1, further comprising a chapter processing module configured to, when an operation is input from the operation input module during recording by the off-timer recording control module, add a chapter to a recording position corresponding to the time when an operation signal was received.

8. The receiver according to claim 1, further comprising a notification processing module configured to, when the broadcast receiver is activated, determines whether a program recorded by the off-timer recording control module exists in the recording medium, and when the program recorded by the off-timer recording control module exists in the recording medium, notify a user that the program recorded by the off-timer recording control module exists in the recording medium.

9. The receiver according to claim 1, further comprising a display module configured to display an image on the basis of the broadcast signal having undergone the predetermined signal processing by the signal processing module.

10. A recording control method for use in a broadcast receiver comprising a receiving module configured to receive a broadcast signal, a signal processing module configured to perform predetermined signal processing on the broadcast signal received by the receiving module, a recording module configured to record, on a recording medium, a signal transmitted from the signal processing module, and an operation input module configured to convert an operation input into an operation signal, the method comprising:
managing an off-timer function on the basis of the operation signal from the operation input module; and
performing control such that:
when an off-timer setting time is set, the recording module starts recording;
when the operation input module is operated during recording to select a channel, the recording of a broadcast signal from the channel selected by the channel selection operation is started; and
when the operation input module is operated during recording to select a channel or switch the broadcast receiver into a standby state, data recorded by off-timer recording on the recording medium when the operation is performed is deleted;
discriminating a program end time on the basis of an output signal output from the signal processing module; and
ending recording when the end of a program recorded when it is determined that the off-timer setting time has come is discriminated.
